(19) United States
(12) Patent Application Publication
(10) Pub. No.: US 2020/0019785 A1
(43) Pub. Date: Jan. 16, 2020

(54) AUTOMATICALLY ASSOCIATING IMAGES WITH OTHER IMAGES OF THE SAME LOCATIONS

(71) Applicant: ELEMENT AI INC., Montreal (CA)

(72) Inventors: Jean-Sébastien BÉJEAU, Montreal (CA); Eric ROBERT, Montreal (CA); Joseph MARINIER, Montreal (CA)

(21) Appl. No.: 16/507,669

(22) Filed: Jul. 10, 2019

Related U.S. Application Data
(60) Provisional application No. 62/695,897, filed on Jul. 10, 2018.

(51) Int. Cl. G06K 9/00; G06K 9/62; G06F 16/583; G06N 3/04

(52) U.S. Cl. CPC G06K 9/00697; G06K 9/00711; G06N 3/04; G06F 16/583; G06K 9/6256

(57) ABSTRACT

System and methods for associating unlabeled images with other, labeled images of the same locations. A high-level signature of each image is generated, representing high-level structural features of each image. A signature of an unlabeled image is then compared to a signature of a labeled image. If those signatures match within a margin of tolerance, the images are interpreted as representing the same location. One or more labels from the labeled image can then be automatically applied to the unlabeled image. In one embodiment, the images are frames from separate video sequences. In this embodiment, entire unlabeled video sequences can be labeled based on a labeled video sequence covering the same geographic area. In some implementations, the high-level signatures are generated by rule-based signature-generation modules. In other implementations, the signature-generation module can be a neural network, such as a convolutional neural network.

### RELATED APPLICATIONS

This application is a non-provisional patent application which claims the benefit of U.S. Provisional Application No. 62/695,897 filed on Jul. 10, 2018.

### TECHNICAL FIELD

The present invention relates to labeled and unlabeled images. More specifically, the present invention relates to systems and methods for associating unlabeled images with other, labeled images of the same locations.

### BACKGROUND

The field of machine learning is a burgeoning one. Daily, more and more uses for machine learning are being discovered. Unfortunately, to properly use machine learning, data sets suitable for training are required to ensure that systems accurately and properly accomplish their tasks. As an example, for systems that recognize cars within images, training data sets of labeled images containing cars are needed. Similarly, to train systems that, for example, track the number of trucks crossing a border, data sets of labeled images containing trucks are required.

As is known in the field, these labeled images are used so that, by exposing systems to multiple images of the same item in varying contexts, the systems can learn how to recognize that item. However, as is also known in the field, obtaining labeled images which can be used for training machine learning systems is not only difficult, it can also be quite expensive. In many instances, such labeled images are manually labeled, i.e., labels are assigned to each image by a person. Since data sets can sometimes include thousands of images, manually labeling these data sets can be a very time-consuming task.

It should be clear that labeling video frames also runs into the same issues. As an example, a 15 minute video running at 24 frames per second will have 21,600 frames. If each frame is to be labeled so that the video can be used as a training data set, manually labeling the 21,600 frames will take hours if not days.

Moreover, manually labeling those video frames will likely introduce substantial error. Selecting, for instance, ‘the red car’ in 21,600 frames is a tedious task in addition to a time-consuming one. The person doing that labeling is likely to lose focus from time to time, and their labels may not always be accurate.

In addition, much of the labeling process is redundant. Multiple images and/or video sequences may show the same locations. As an example, multiple videos may show the same stretch of road or railroad. Manually labeling features of each individual frame in each sequence would then be an extremely repetitive task.

Many machine vision techniques have been developed to address these issues.

However, these techniques can be easily misled by small changes in an image. For instance, an image of a certain location that was captured in late spring may appear very different, on a detailed level, from an image of the same location that was taken from the same vantage point in the middle of winter. Although high-level structural features of the image (roads, trees, geographic formations, buildings, etc.) may be the same in both images, the granular details of the image may confuse typical techniques.

Additionally, many common techniques perform image similarity detection based on histograms or other pixel-based visual features. Thus, these techniques generally do not provide enough resolution for precise image alignment, as they are sensitive to variations in pixel colour (e.g., sunny vs. cloudy; grass vs. snow covering grass; tree with and without leaves), instead of using higher level abstractions (e.g., there is a large tree near a house that has stone-like walls).

From the above, there is therefore a need for systems and methods that overcome the problems of both manual and typical machine vision techniques. Preferably, such systems and methods would work to ensure that labels on labeled images are accurately placed on unlabeled images of the same locations.

### SUMMARY

The present invention provides a system and methods for associating unlabeled images with other, labeled images of the same locations. A high-level signature of each image is generated, representing high-level structural features of each image. A signature of an unlabeled image is then compared to a signature of a labeled image. If those signatures match within a margin of tolerance, the images are interpreted as representing the same location. One or more labels from the labeled image can then be automatically applied to the unlabeled image. In one embodiment, the images are frames from separate video sequences. In this embodiment, entire unlabeled video sequences can be labeled based on a labeled video sequence covering the same geographic area. In some implementations, the high-level signatures are generated by rule-based signature-generation modules. In other implementations, the signature-generation module can be a neural network, such as a convolutional neural network.

In a first aspect, the present invention provides a method for associating an unlabeled image with a labeled image, the method comprising:
(a) receiving said unlabeled image and said labeled image, said labeled image having at least one label;
(b) generating a first signature based on said labeled image;
(c) generating a second signature based on said unlabeled image;
(d) comparing said second signature to said first signature; and
(e) applying said at least one label to said unlabeled image when said second signature matches said first signature,
   wherein said second signature matches said first signature when a difference between said first signature and said second signature is within a margin of tolerance,
   and wherein said unlabeled image and said labeled image are interpreted as having a same location when said second signature matches said first signature.

In a second aspect, the present invention provides a method for associating an unlabeled frame with a labeled frame, the method comprising:
(a) receiving said unlabeled frame and said labeled frame, wherein said unlabeled frame is from an unlabeled sequence of unlabeled frames and said labeled frame is from a labeled sequence of labeled frames, and wherein each labeled frame in said labeled sequence has at least one label;
(b) generating at least one first signature based on at least one labeled frame in said labeled sequence;
(c) generating at least one second signature based on at least one unlabeled frame in said unlabeled sequence;
(d) comparing said at least one first signature to said at least one second signature; and
(e) applying said at least one label to said at least one unlabeled frame when said at least one first signature matches said second signature,
   wherein said at least one first signature matches said at least one second signature when a difference between said at least one first signature and said at least one second signature is within a margin of tolerance,
   and wherein said unlabeled frame and said labeled frame are interpreted as having a same location when said at least one first signature matches said at least one second signature.

In a third aspect, the present invention provides a system for associating an unlabeled image with a labeled image, the system comprising:
a signature-generation module for:
   receiving said unlabeled image and a labeled image, said labeled image having at least one label;
   generating a first signature based on said labeled image; and
   generating a second signature based on said unlabeled image; and
an execution module for:
   comparing said second signature to said first signature; and
   applying said at least one label to said unlabeled image when said second signature matches said first signature,
      wherein said second signature matches said first signature when a difference between said first signature and said second signature is within a margin of tolerance,
      and wherein said unlabeled image and said labeled image are interpreted as having a same location when said second signature matches said first signature.

In a fourth aspect, the present invention provides non-transitory computer-readable media having encoded thereon computer-readable and computer-executable instructions, which, when executed, implement a method for associating an unlabeled image with a labeled image, the method comprising:
(a) receiving said unlabeled image and said labeled image, said labeled image having at least one label;
(b) generating a first signature based on said labeled image;
(c) generating a second signature based on said unlabeled image;
(d) comparing said second signature to said first signature; and
(e) applying said at least one label to said unlabeled image when said second signature matches said first signature,
   wherein said second signature matches said first signature when a difference between said first signature and said second signature is within a margin of tolerance,
   and wherein said unlabeled image and said labeled image are interpreted as having a same location when said second signature matches said first signature.

In a fifth aspect, the present invention provides non-transitory computer-readable media having encoded thereon computer-readable and computer-executable instructions, which, when executed, implement a method for associating an unlabeled frame with a labeled frame, the method comprising:
(a) receiving said unlabeled frame and said labeled frame, wherein said unlabeled frame is from an unlabeled sequence of unlabeled frames and said labeled frame is from a labeled sequence of labeled frames, and wherein each labeled frame in said labeled sequence has at least one label;
(b) generating at least one first signature based on at least one labeled frame in said labeled sequence;
(c) generating at least one second signature based on at least one unlabeled frame in said unlabeled sequence;
(d) comparing said at least one first signature to said at least one second signature; and
(e) applying said at least one label to said at least one unlabeled frame when said at least one first signature matches said second signature,
   wherein said at least one first signature matches said at least one second signature when a difference between said at least one first signature and said at least one second signature is within a margin of tolerance,
   and wherein said unlabeled frame and said labeled frame are interpreted as having a same location when said at least one first signature matches said at least one second signature.

### BRIEF DESCRIPTION OF THE DRAWINGS

The present invention will now be described by reference to the following figures, in which identical reference numerals refer to identical elements and in which:

FIG. 1 is a block diagram of a system according to one aspect of the invention;

FIG. 2A is an exemplary image of a location;

FIG. 2B is another exemplary image of the location in FIG. 2A, captured at a different time;

FIG. 3 is a diagram showing a labeled video sequence and an unlabeled video sequence;

FIG. 4 is a block diagram showing the system of FIG. 1, configured to receive the video sequences of FIG. 3, according to another embodiment of the invention;

FIG. 5 is a flowchart detailing the steps in a method according to another aspect of the invention; and

FIG. 6 is another flowchart detailing the steps in a different method, according to another aspect of the invention.

### DETAILED DESCRIPTION

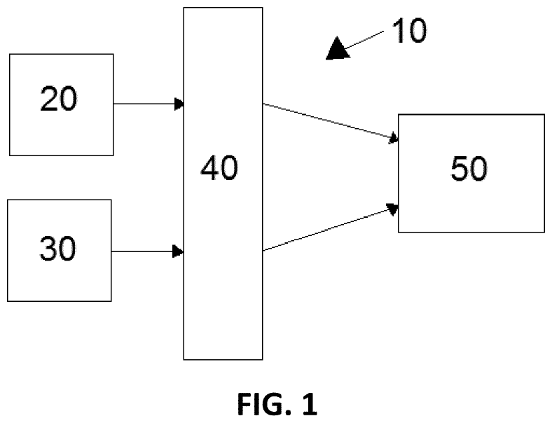

The present invention provides systems and methods that allow for automatically associating unlabeled images with other, labeled images of the same location. FIG. 1 is a block diagram of a system according to one aspect of the invention. The system 10 receives a labeled image 20 and an unlabeled image 30. The labeled image 20 and the unlabeled image 30 are received by a signature-generation module 40, which generates high-level “signatures” of each of the labeled and unlabeled images. These high-level signatures are then passed to an execution module 50, which compares the signatures to each other and determines whether they match. If the image signatures match, the labeled image 20 and the unlabeled image 30 are interpreted as representing the same location. The execution module 50 can then apply the at least one label from the labeled image 20 to the unlabeled image 30.

The labels/tags on the labeled image 20 are pre-existing labels/tags (i.e., the labels/tags are applied before the labeled image 20 is received by the system 10). Labels/tags on the labeled image 20 can include bounding boxes that each define a region of the labeled frame, wherein a specific item is contained within each bounding box. (It should be evident, of course, that a ‘bounding box’ does not have to be rectangular. The term ‘bounding box’ as used herein (and, further, the terms ‘label’ and ‘tag’) indicates an element of any shape, size, or form that delineates, highlights, or separates a feature from the rest of the frame.) In other implementations, the label/tag can include a metadata tag applied to the labeled frame as a whole, indicating the presence or absence of a specific feature within the frame as a whole. Additionally, the label/tag can indicate the location of that specific feature within the frame. In some implementations, labels/tags might function both as binary present/absent indicators and as locators. Additionally, the at least one label/tag associated with the labeled image 20 is available to the rest of the system. Conversely, of course, before being received by the system, the ‘unlabeled’ image 30 does not have a label/tag.

In some implementations, all labels from the labeled image are applied to the unlabeled image. In certain implementations, labels may be applied to transitory features of the labeled image. (Transitory features are features that may not remain in the same location over time (e.g., cars, animals, etc.). Thus, transitory features in the labeled image might not appear in the unlabeled image.) Such implementations may be configured so that only a portion of the labels from the labeled image (those corresponding to structural or non-transitory features) are applied to the unlabeled image. That is, in such cases, as the transitory features will not be found in the unlabeled image, their corresponding labels will not be applied. In other implementations, the labeled image received by the invention is labeled so that the label(s)/tag(s) correspond only to structural features of the image.

It should also be clear that the “location” represented by the images 20 and 30 is not required to be a real-world location. That is, the present invention may be configured to work with images of simulated locations, provided that one image has at least one label. Simulated locations may appear, for instance, in video games or in autonomous vehicle simulators, or in artificial or virtual reality scenarios. Although images of these simulated locations may carry location information in their metadata, that location information may not be fully accessible to third parties.

The signature generated by the signature-generation module 40 may be generated according to various well-known image similarity techniques or such techniques in combination. Image similarity detection may include image segmentation techniques, which are well-known in the art (see for instance, Zaitoun & Aqel, “Survey on Image Segmentation Techniques”, International Conference of Communication, Management and Information Technology, 2015, the entirety of which is hereby incorporated by reference). Many possible signature-generation mechanisms exist, including those based on “edge/boundary detection”, “region comparisons”, and “shape-based clustering”, among others. The signature-generation module 40 of the present invention may thus be configured according to many different techniques.

The signature-generation module 40 can thus be a rule-based module for image segmentation. However, the signature-generation module 40 preferably includes a neural network. Neural networks typically comprise many layers. Each layer performs certain operations on the data that each layer receives. A neural network can be configured so that its output is a simplified “embedding” (or “representation”) of the original input data. The degree of simplification depends on the number and type of layers and the operations they perform.

It is possible, however, to only use a portion of the available layers in a neural network. For instance, an image can be passed to a neural network having 20 internal layers, but only processed by the 18th or 19th layer, or those layers in combination. An embedding retrieved after only a few high-level layers have processed the video frame would therefore contain fairly high-level information. Such an embedding may be thought of as a “signature” of the initial image. This signature is detailed enough to capture high-level structural features of the image (again, these “structural features” may include such large-scale features as roads, trees, road signals, geographic formations, buildings, and so on). The signatures resulting from this signature-generation module 40 are, however, sufficiently high-level as to not include information on detailed or granular features of the image (such as details on the road condition or sky colour, etc.).

In implementations using a neural network, the neural network is preferably a pre-trained convolutional neural network (CNN). CNNs are known to have advantages over other neural networks when used for image processing.

The signatures produced by the signature-generation module 40 are typically numerical tensors. Non-numerical signatures are possible, however, depending on the configuration of the signature-generation module 40.

The signature-generation module 40 in FIG. 1 would thus receive the labeled image 20 and the unlabeled image 30. The signature-generation module 40 would separately generate a first signature based on the labeled image 20, and a second signature based on the unlabeled image 30, according to the methods described above. These signatures are then passed to the execution module 50.

The execution module 50 compares the second signature to the first signature. The execution module 50 may use such well-known operations as cosine distance, covariance, and correlation as the basis for rule-based comparisons. However, in some implementations, the execution module 50 is another neural network. This other neural network is trained to compare signatures and determine points of importance within them. Data on those points of importance can then inform later comparisons.

It should be noted that in many implementations of the present invention, an exact match between image signatures is unlikely. That is, depending on the exact vantage points at which two images of the same location are captured, the precise locations of structural features within an image are likely to shift slightly from image to image. Exact signature matches may thus not be possible. To account for this, the execution module 50 is preferably configured to determine matches within a margin of tolerance. That margin of tolerance should be set to a level that various slight differences between images, while still ensuring that the overall structural features of the images match. Thus, the margin of tolerance used may vary depending on the images in question.

Additionally, the margin of tolerance should be set to a level that accounts for transitory features, as described above. For instance, images of a busy intersection can be assumed to be “noisy”; that is, to contain many transitory features that will not be present across time. Thus, a margin of tolerance associated with those images should be high enough to account for that noise level. Conversely, images in a rural location may be assumed to contain a lower level of noise.

Because each signature is distinct and detailed, when a match is found between a second signature and a labeled-image signature, it can be concluded that the unlabeled image and the labeled image from which those signatures were generated are images of the same location. Thus, any structural features in the labeled image would also appear in the unlabeled image. The execution module 50 can then apply any labels from the labeled image to the matching unlabeled image.

In some implementations, when the execution module 50 determines that the first signature and the second signature do not match within the margin of tolerance described above, the unlabeled image 30 can then be sent to a human for review. After review, the unlabeled image 30 may be fed back to the system 10 to be used in a training set to further train the system 10.

As should also be evident, in some embodiments of the invention, the execution module 50 can be a single module. In other embodiments, however, the execution module 50 can comprise separate modules for each task (i.e., a comparison module for comparing signatures, and a labeling module for applying labels to an unlabeled image when a matching labeled image is found).

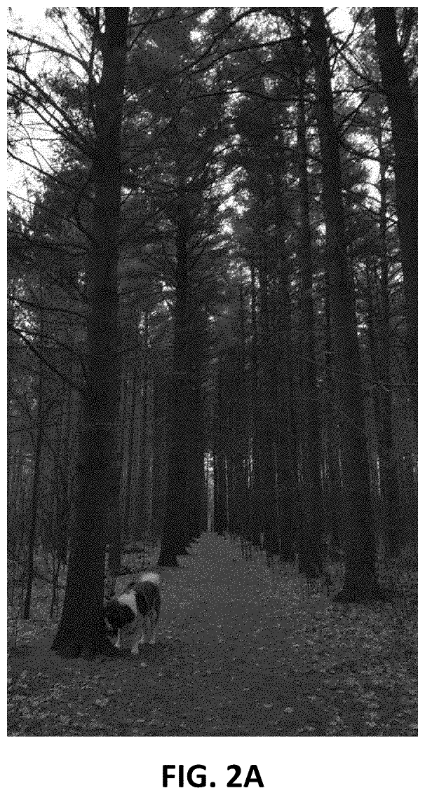

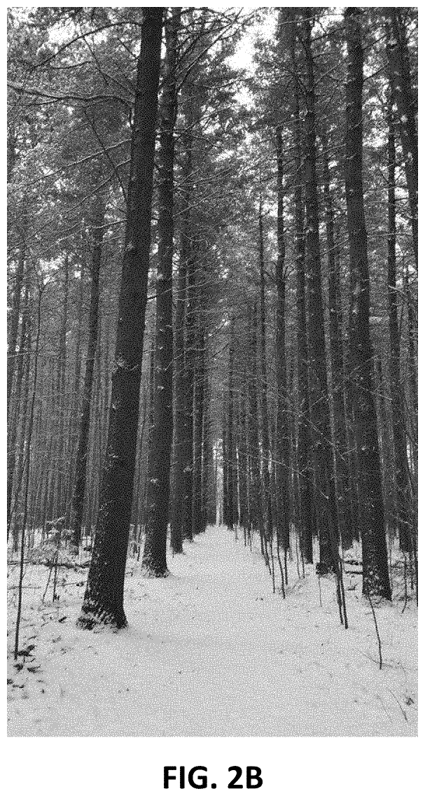

Referring now to FIGS. 2A and 2B, exemplary images that could be used by the present invention are shown. The image in FIG. 2A was captured in a wooded location in late fall. As can be seen, a dirt path runs down the centre of the image and various trees on either side of that path. Additionally, there are leaves on the ground, particularly under the trees, and there is a dog near the bottom of the image.

As can be imagined, FIG. 2A might have labels corresponding to the road or to one or more of the trees.

FIG. 2B shows the same wooded location that is shown in FIG. 2A, from approximately the same vantage point. The high-level structural features of the image (the path in the centre, the trees, etc.) are in approximately the same places in FIG. 2B as they were in FIG. 2A. As can be seen, however, the image in FIG. 2B was captured at a different point in time from the image in FIG. 2A: where FIG. 2A had open ground and fallen leaves, the path and ground shown in FIG. 2B are covered by a layer of snow. Additionally, many of the tree branches in FIG. 2B are outlined in snow.

For the purposes of this example, one can assume that the image in FIG. 2A has at least one label corresponding to a structural feature, and that the image in FIG. 2B is unlabeled. Using these assumptions, these images can then be fed to the signature-generation module 40. (FIG. 2A would thus be the labeled image 20. FIG. 2B would be the unlabeled image 30.) The signature-generation module 40 would then generate a high-level signature for each image. Depending on the configuration of the signature-generation module 40, each of those signatures might contain information on the road and the trees, but not on the colour or texture of the ground area. The signatures could then be passed to the execution module 50 for comparison. With an appropriate margin of tolerance set, the two signatures should match. That matching would indicate that the images show approximately the same location (of course, within the set margin of tolerance), and that, therefore they share structural features. One or more labels applied to the image in FIG. 2A can then be applied to the image in FIG. 2B, resulting in a newly labeled image.

In another embodiment of the invention, the labeled image 20 and the unlabeled image 30 can be video frames from separate video sequences. That is, the labeled image 20 can be a labeled frame from a sequence of labeled frames, and the unlabeled image 30 can be an unlabeled frame from a sequence of unlabeled frames.

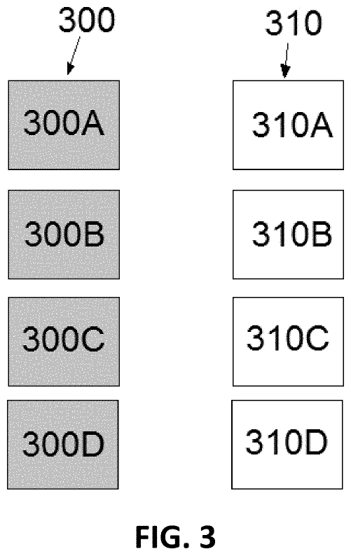

FIG. 3 is a diagram showing a labeled sequence 300 of labeled frames 300A-300D and an unlabeled sequence 310 of unlabeled frames 310A-310D. Each labeled frame 300A-300D in the labeled sequence 300 has at least one label.

Note that the labeled frames 300A-300D are coloured light grey in FIG. 3. It should of course be understood that this colouring is purely for visual distinction within the diagram. It should also be understood that the sequences 300 and 310 in FIG. 3 are simplified for exemplary purposes. As discussed above, video sequences may comprise many hundreds or thousands of frames, or more, depending on the video's length and frame rate.

For ease of comparison, it is preferable that the two sequences 300 and 310 have the same frame rate and represent the same geographic distance. However, the two sequences may or may not be the same duration. That is, as may be understood, it is not necessary for the labeled and unlabeled frames to have a one-to-one relationship. In some cases, multiple frames from the delayed sequence might all correspond to the same frame in the non-delayed sequence. The geographic location represented by the multiple frames would thus be the location at which the train stopped to wait.

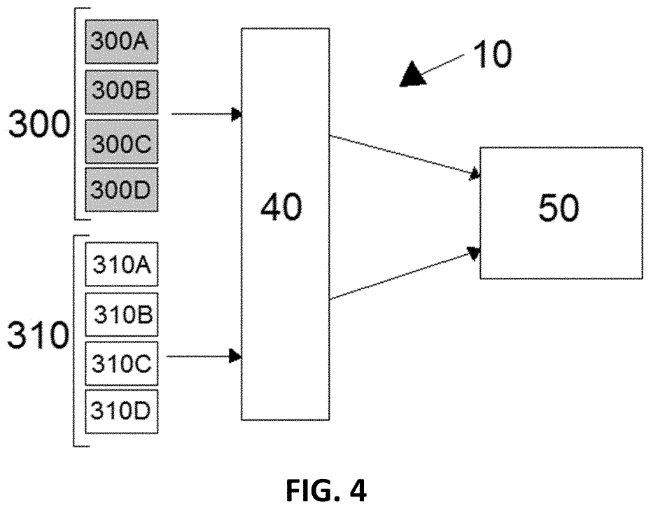

FIG. 4 is a block diagram showing the system 10 of FIG. 1, configured to receive video sequences. As can be seen, the signature-generation module 40 can receive entire video sequences, such as labeled sequence 300 and unlabeled sequence 310. Then, the signature-generation module 40 can generate a signature for each separate labeled frame 300A, 300B, 300C, and 300D. In some implementations, signatures for all labeled frames can be generated in a single batch and stored for later comparisons. In other implementations, a signature for each labeled frame can be generated on an as-needed basis when they are to be compared. The signature-generation module 40 also generates a signature for each unlabeled frame 310A, 310B, 310C, and 310D. Again, signatures for all the unlabeled frames may be generated at one time, or may be generated individually on an as-needed basis. In some implementations, it may be preferable to generate signatures for unlabeled frames on an as-needed basis while generating signatures for labeled frames in a single batch (and, of course, vice versa). Such an approach would efficiently account for potential time discrepancies between the video sequences. In such implementations, the signature-generation module 40 can generate a signature for a first unlabeled frame from the unlabeled sequence 310. That first unlabeled frame can be any frame from the unlabeled sequence 310. For efficiency reasons, it is preferable that this first frame in the unlabeled sequence 310 (i.e., frame 310A).

The generated signatures are passed to the execution module 50. The execution module 50 then compares the signature of the first unlabeled frame to a specific signature of a specific labeled frame, using a margin of tolerance as described above. Depending on the implementation, it may be preferable for that specific labeled frame to be the first labeled frame in the labeled sequence 300 (i.e., to labeled frame 300A).

If the signature of the first unlabeled frame matches the signature of the specific labeled frame, the execution module 50 applies one or more labels from the specific labeled frame to the first unlabeled frame. On the other hand, if the signature of the first unlabeled frame does not match the signature of the specific labeled frame, the execution module 50 selects a signature of another labeled frame. The execution module 50 compares the signature of the first unlabeled frame to that newly selected signature. Again, if these signatures match, one or more labels from the labeled frame corresponding to that newly selected signature may be applied to the first unlabeled frame. If these signatures do not match, a signature of another new labeled frame may be selected for comparison. For convenience, the video sequences begin at approximately the same geographic location. In this case, a matching signature should be found for the unlabeled frame after only a few comparisons. It should be clear to a person skilled in the art that the number of possible comparisons for a signature of any individual unlabeled frame should be limited. If the number is not limited, there is a possibility of an infinite loop occurring. If that predetermined number of possible comparisons is reached for a signature of any given unlabeled frame, it can be concluded that the unlabeled frame does not match any labeled frame in the labeled sequence. In some implementations, the unlabeled frame can be sent to a human for review and potentially fed back to the system 10 to be used in a training set to further train the system 10.

Once a signature for an unlabeled frame has been found to match a signature for a labeled frame, one or more labels from the labeled frame have been applied to the matching unlabeled frame. The signature-generation module 40 can generate a new signature based on a new unlabeled frame chosen from the unlabeled sequence 310. For efficiency, it is generally preferable that this new unlabeled frame be adjacent to the first unlabeled frame from the sequence, meaning that there are no other frames between the first unlabeled frame and this new unlabeled frame in the unlabeled sequence 310. As an example, if the first unlabeled frame was 310A, it is generally preferable that the new unlabeled frame be 310B. However, in other implementations, the new unlabeled frame may not be adjacent to the first unlabeled frame. Such other implementations may be preferable depending on the user's needs.

The signature of the new unlabeled frame is then passed to the execution module 50 and compared to signatures of the labeled frames, as described above for the signature of the first unlabeled frame. Once a labeled frame is found that matches that new unlabeled frame, one or more labels may be applied to the unlabeled frame. A signature is generated for a third unlabeled frame from the unlabeled sequence 310 (e.g., for unlabeled frame 310C), and the comparison/labeling process repeated once again. This overall signature-generation/comparison/labeling process repeats until all unlabeled frames in the unlabeled sequence 310 have been processed.

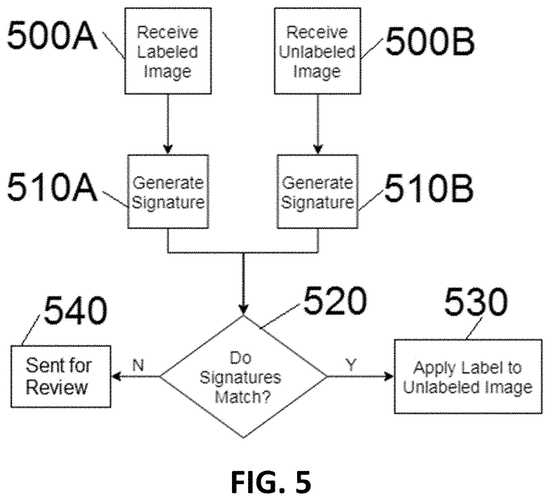

FIG. 5 is a flowchart detailing the steps in a method according to one embodiment of another aspect of the present invention. A labeled image, as described above, is received at step 500A and an unlabeled image is received at step 500B. At step 510A, a first signature is generated based on the labeled image. At step 510B, similarly, a second signature is generated based on the unlabeled image. Note that each image must be received before a signature based on the image can be generated. Bearing that in mind, the order of steps 500A, 500B, 510A, and 510B can be altered or adjusted as necessary.

Once both a signature of the labeled image and a signature of the unlabeled image have been generated at steps 510A and 510B, respectively, the signatures are compared at step 520. If the signatures match (within the margin of tolerance as described above), one or more labels from the labeled image are applied to the unlabeled image (step 530). If the signatures do not match, however, the unlabeled image can be sent to a human for review at step 540.

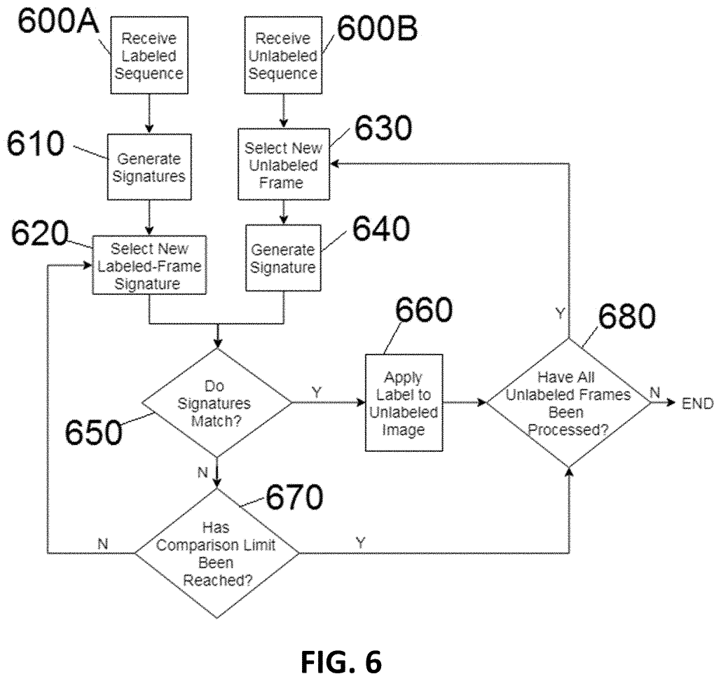

FIG. 6 is another flowchart detailing the steps in a method according to a different embodiment of another aspect of the present invention. In this embodiment, the signature-generation module is configured to receive full image sequences, as in FIG. 4 above. The method begins at steps 600A and 600B. At step 600A, a labeled sequence of labeled frames is received. At step 600B, similarly, an unlabeled sequence of unlabeled frames is received.

As discussed above, signatures of labeled frames and unlabeled frames can be generated individually on an as-needed-for-comparison basis. Alternatively, the signatures of labeled frames and the signatures of unlabeled frames can be generated in separate batches and stored for later comparison. As a further alternative, signatures of labeled frames can be generated in a batch while signatures of unlabeled frames are generated on an as-needed basis, as shown in FIG. 6. The reverse is also possible (i.e., the signatures of labeled frames being generated on an as-needed basis while the signatures of the unlabeled frames are generated in a batch), depending on the specific implementation.

Again, FIG. 6 details an implementation of the method in which signatures of the labeled frames are generated in a single batch and a signature of each unlabeled frames is generated on an as-needed basis. The 1 signatures of the labeled frames are generated at step 610. One of these generated signatures is selected at step 620, to be used in later comparisons. As mentioned above, it may often be preferable for the first selected labeled-frame signature to correspond to the first frame in the labeled sequence.

Meanwhile, at step 630, an unlabeled frame is selected from the unlabeled sequence. Again, it is generally preferable for that unlabeled frame is the first frame from the unlabeled sequence. A signature is then generated based on that selected unlabeled frame, at step 640.

At step 650, the signature for the selected unlabeled frame from step 640 is compared to the selected signature for a labeled frame from step 620. If the signatures match (within a predetermined margin of tolerance, as described above), one or more labels from the labeled frame are applied to the unlabeled frame (step 660). Then, at step 680, the original unlabeled sequence is examined. If any frames from the unlabeled sequence have not yet been processed (that is, a corresponding signature has not yet been generated and compared to signatures of labeled frames), the method returns to step 630 and a new unlabeled frame from the unlabeled sequence is selected. (Clearly, this new unlabeled frame is one that has not yet been processed. As mentioned above, for efficiency, the new unlabeled frame is preferably adjacent to the original unlabeled frame in the unlabeled sequence.)

Returning to step 650, the signature of the unlabeled frame might not match the selected labeled-frame signature within the predetermined margin of tolerance. In this case, step 670 determines whether a predetermined comparison limit (i.e., a predetermined maximum number of possible comparisons) has been reached. If this comparison limit has not been reached, the method returns to step 620 and a new labeled-frame signature is selected for comparison to the signature of the unlabeled frame.

If the comparison limit has been reached, however, it can be concluded that the unlabeled frame does not have a matching frame in the labeled sequence. At this point, the unlabeled frame can be sent to a human for review, and potentially fed back to the system. The method then returns to step 680. At step 680, then, the unlabeled sequence would be examined as described above.

When the examination at step 680 determines that all unlabeled frames from the original unlabeled sequence have been processed, the entire unlabeled sequence is labeled (or alternatively, flagged for review) and the method is complete.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media labeled in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for associating an unlabeled image with a labeled image, the method comprising:
(a) receiving said unlabeled image and said labeled image, said labeled image having at least one label;
(b) generating a first signature based on said labeled image;
(c) generating a second signature based on said unlabeled image;
(d) comparing said second signature to said first signature; and
(e) applying said at least one label to said unlabeled image when said second signature matches said first signature,
wherein said second signature matches said first signature when a difference between said first signature and said second signature is within a margin of tolerance,
and wherein said unlabeled image and said labeled image are interpreted as having a same location when said second signature matches said first signature.

2. The method according to claim 1, wherein said first signature and said second signature are generated by a neural network.

3. The method according to claim 2, wherein said neural network is a convolutional neural network.

4. The method according to claim 1, wherein said first signature and said second signature are numerical tensors.

5. The method according to claim 1, wherein said labeled image is from a first video sequence and said unlabeled image is from a second video sequence.

6. A method for associating an unlabeled frame with a labeled frame, the method comprising:
(a) receiving said unlabeled frame and said labeled frame, wherein said unlabeled frame is from an unlabeled sequence of unlabeled frames and said labeled frame is from a labeled sequence of labeled frames, and wherein each labeled frame in said labeled sequence has at least one label;
(b) generating at least one first signature based on at least one labeled frame in said labeled sequence;
(c) generating at least one second signature based on at least one unlabeled frame in said unlabeled sequence;
(d) comparing said at least one first signature to said at least one second signature; and
(e) applying said at least one label to said at least one unlabeled frame when said at least one first signature matches said second signature,
wherein said at least one first signature matches said at least one second signature when a difference between said at least one first signature and said at least one second signature is within a margin of tolerance,
and wherein said unlabeled frame and said labeled frame are interpreted as having a same location when said at least one first signature matches said at least one second signature.

7. The method according to claim 6, wherein at least one new unlabeled frame in said unlabeled sequence is selected when said at least one first signature does not match said at least one second signature, and steps (c)-(e) are repeated with said at least one new unlabeled frame in place of said at least one unlabeled frame until an exit condition is reached, wherein said exit condition is one of:
said at least one first signature matches said at least one second signature; and
a predetermined number of comparisons is reached.

8. The method according to claim 6, wherein steps (b)-(e) are repeated until all unlabeled frames in said unlabeled sequence have been processed.

9. The method according to claim 6, wherein said first unlabeled frame is an initial frame in said unlabeled sequence and said new unlabeled frame is a frame in said unlabeled sequence that is adjacent to said first unlabeled frame.

10. The method according to claim 6, wherein said first signature and said second signature are generated by a neural network.

11. The method according to claim 10, wherein said neural network is a convolutional neural network.

12. The method according to claim 6, wherein said first signature and said second signature are numerical tensors.

13. A system for associating an unlabeled image with a location, the system comprising:
a signature-generation module for:
receiving said unlabeled image and a labeled image, said labeled image having at least one label;
generating a first signature based on said labeled image; and
generating a second signature based on said unlabeled image; and
an execution module for:
comparing said second signature to said first signature; and
applying said at least one label to said unlabeled image when said second signature matches said first signature,
wherein said second signature matches said first signature when a difference between said first signature and said second signature is within a margin of tolerance,
and wherein said unlabeled image and said labeled image are interpreted as having a same location when said second signature matches said first signature.

14. The system according to claim 13, wherein said signature-generation module comprises a neural network.

15. The system according to claim 14, wherein said neural network is a convolutional neural network.

16. The system according to claim 13, wherein said first signature and said second signature are numerical tensors.

17. The system according to claim 13, wherein said execution module further comprises a comparison module and a labeling module.
